(19) United States
(12) Patent Application Publication
(10) Pub. No.: US 2004/0052622 A1
(43) Pub. Date: Mar. 18, 2004

(54) Powered moveable stowage

(75) Inventor: David Chisnall, Southhampton (GB)

Correspondence Address: DORITY & MANNING, P.A., POST OFFICE BOX 1449, GREENVILLE, SC, 29602-1449, US

(73) Assignee: AS Fire & Rescue Equipment Ltd., a United Kingdom limited corporation

(21) Appl. No.: 10/617,132

(22) Filed: Jul. 10, 2003

(30) Foreign Application Priority Data
Jul. 11, 2002 (GB) GB0215996.0

(51) Int. Cl. B60R 9/00; B60R 9/042; B60P 9/00

(52) U.S. Cl. 414/462; 224/310; 224/321

(57) ABSTRACT

A vehicle has on its top a moveable stowage comprising a longitudinal member 10 on which is Mounted a transmission means 11 driven by a motive force 12 and an attachment means 14 by which the stowed item 15 is attached to and moved on to and off the stowage, the longitudinal member 10, propelled by a second transmission means 18 powered by a second motive force 19, moves on a base member 16 that is pivotally attached to a mounting 17, a third motive force 21 causing the base member 16 to pivot about the mounting 17 the total combined movements transporting the stowed item to and from the access position shown to and from a stowage position on top of the vehicle.

This invention relates to the stowage of equipment such as ladders on the top of vehicles and in particular with a means by which these items can be conveniently loaded and unloaded in a controlled manner by an operator standing on the ground.

Fire brigades commonly carry ladders and other equipment on top of their vehicles. Health and safety requirements now necessitate that these items are accessed from ground level and manual handling limits restrict the amount of effort available from the operators. Existing systems designed to meet this requirement utilise the operators to provide the motive force required to move the stowage and the item upon it. Various means are also used to control the movements during the transition from the horizontal stowed state to the near vertical access position. Such systems have the disadvantage of requiring the operators to provide the motive power and thereby increasing the number of operators required as well as restricting the scope of permitted operation.

An object of this invention is to provide a roof top stowage that is operable from ground level and is powered throughout its movement and that of the stowed item upon it whilst requiring minimal input from a single operator.

According to this invention there is provided a moveable stowage on top of a vehicle comprising a longitudinal member, means for releasably securing the longitudinal member in the stowed position, the longitudinal member being adapted to travel over a base member that is pivotally mounted on the vehicle so as to move the longitudinal member from a substantially horizontal stowed position to an angular access position, and upon said longitudinal member a moveable attachment for connecting the stowed item to the longitudinal member such that the stowed item can be moved on to and off the longitudinal member, all movements being caused and controlled by powered means.

A specific embodiment of this invention will now be described by way of example only and with reference to the accompanying drawings of which:—

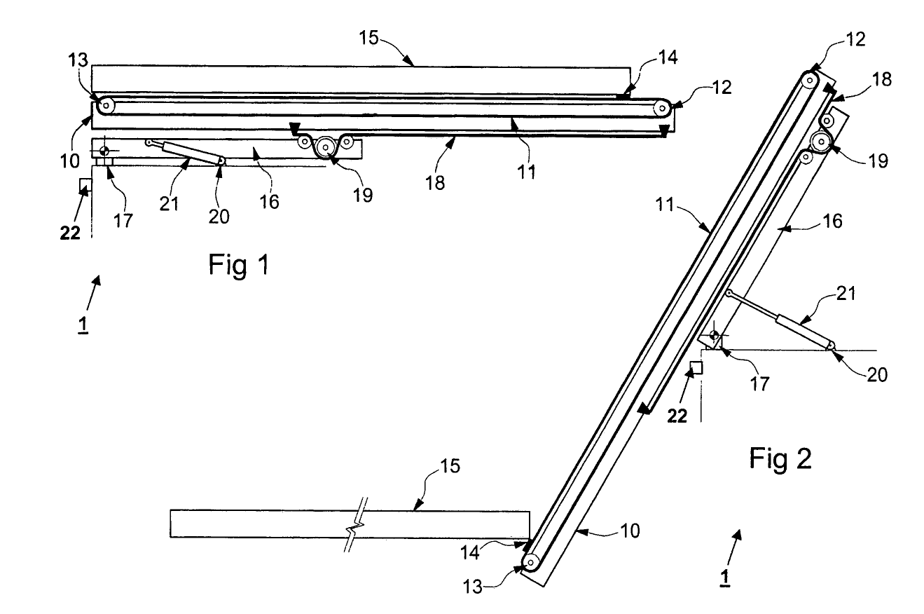

FIG. 1 is a diagrammatic view showing the stowage in the stowed position, the stowage being viewed from a location displaced to the right of the stowage.

FIG. 2 is a view similar to FIG. 1 illustrating the stowage in the access position.

A vehicle such as a fire tender used by the fire brigades has on its top a moveable stowage for a ladder. A moveable stowage comprising a longitudinal member 10, means (not shown) for releasably securing the longitudinal member 10 in the stowed position shown in FIG. 1. Mounted on the longitudinal member 10 a closed loop transmission means 11 driven by a motive force 12 and tensioned and returned by a returning means 13. An attachment means 14 by which the stowed item 15 is attached to the stowage, forms part of the transition means 11 where bye the stowed item 15 may be propelled back and forth along the longitudinal member 10 using guide means (not shown). The longitudinal member 10 being adapted to move back and forth on a second guide means (not shown), to and from a stowed position (see FIG. 1) on a base member 16 pivotally attached to a mounting 17 allowing it to pivot to an access position as shown in FIG. 2. The longitudinal member 10 also comprising a linear second transmission means 18 that is powered by a second motive force 19 such that the longitudinal member 10 can be propelled in its movements on the base member 16. Attached to the base member 16 and also to a second mounting 20 a third motive force 21 exerts forces to the base member 16 off set to the pivot causing it to pivot about the mounting 17 to and from the stowage position shown in FIG. 2. A control system (not shown) consisting of a number of sensors (not shown) that sense the ends of the movements and ensures their operation in the correct order and for the necessary duration. The sequence of events being that the latch (not shown) retaining the longitudinal member 10 is released and the motive force 19 propels by the linear transmission means 18 the longitudinal member 10 along the base member 16 away from the stowed position shown in FIG. 1 to a pre-set position. The third motive force 21 then exerts a force between the base member 16 and the second mounting 20 pivoting the base member 16 about the mounting 17 until the access position shown in FIG. 2 is reached. The motive force 12 then exerts a force via the closed loop transmission means 11 around the returning means 13 causing the attachment means 14 together with the stowed item 15 to traverse the longitudinal member 10 to the access position shown in FIG. 2. Transition from the access position shown in FIG. 1 to the stowed position shown in FIG. 2 is achieved by the motive force 12 exerting a force causing the attachment means 14 together with the stowed item 15 to traverse the longitudinal member 10 to the stowage position on the longitudinal member 10 shown in FIG. 2. The third motive force 21 then exerts a force between the base member 16 and the second mounting 20 pivoting the base member 16 about the mounting 17 until the substantially horizontal stowage position of the base member 16 shown in FIG. 2 is reached. Then the motive force 19 propels the linear second transmission means 18 thereby moving the longitudinal member 10 along guide means (not shown) on the base member 16 away from the pre-set position shown in FIG. 2 to the stowed position shown in FIG. 1.

1. A moveable stowage on top of a vehicle comprising a longitudinal member upon which is mounted an attachment means for connecting the stowed item, the attachment means being adapted to travel along the longitudinal member and being moveable by powered means between a stowed position and an access position, the longitudinal member being adapted to travel over a base member that is secured pivotally to the vehicle, the longitudinal member being moveable over the base member by powered means between a stowed position and an access position, means for releasably securing the longitudinal member in the stowed position and stop means to hold the longitudinal member in an access position on the base member, a powered means for pivotally moving the base member between a substantially horizontal stowed position and an angular access position approaching the vertical and stop means for holding the base member in an access position.

2. A moveable stowage as claimed in claim 1, wherein the powered means on the longitudinal member to which the stowed item is attached is in the form of a closed loop formed by but not limited to a belt or a chain running around a pair of sprockets at least one of which is power driven.

3. A moveable stowage as claimed in claim 1 or 2, wherein the powered means moving the longitudinal member over the Base member is in the form of but not limited to a single belt or a chain running around a sprocket which is power driven.

4. A moveable stowage assembly as claimed in any of claims 1 to 3, wherein the force pivoting the base member is provided by but not limited to a liner acting cylinder or actuator.

5. A moveable stowage assembly as claimed in any of claims 1 to 4, wherein the motive power is provided by hydraulic, electric or pneumatic means

6. A moveable stowage assembly as claimed in any of claims 1 to 5, wherein sensors are used connected to a control system to sequence and regulate the movements of the stowage.

7. A moveable stowage substantially as described herein with reference to FIGS. 1 and 2 of the accompanying drawings.
